(19) United States
(12) Patent Application Publication
(10) Pub. No.: US 2024/0393113 A1
(43) Pub. Date: Nov. 28, 2024

(54) Inertial Sensor Module And Electronic Apparatus

(71) Applicant: SEIKO EPSON CORPORATION, Tokyo (JP)

(72) Inventor: Masayasu SAKUMA, Shiojiri (JP)

(21) Appl. No.: 18/672,508

(22) Filed: May 23, 2024

(30) Foreign Application Priority Data
May 26, 2023 (JP) 2023-086769

(51) Int. Cl. G01C 19/56; G01P 15/125; G01P 15/18

(52) U.S. Cl. CPC G01C 19/56; G01P 15/125; G01P 15/18

(57) ABSTRACT

An inertial sensor module includes a first inertial sensor that detects a physical quantity of a first axis; a second inertial sensor that detects the physical quantity of the first axis; a first substrate on which the first inertial sensor and the second inertial sensor are mounted; and a second substrate on which the first substrate is mounted and which includes a first terminal electrically coupled to the first inertial sensor via the first substrate and a second terminal electrically coupled to the second inertial sensor via the first substrate.

The present application is based on, and claims priority from JP Application Serial Number 2023-086769, filed May 26, 2023, the disclosure of which is hereby incorporated by reference herein in its entirety.

### BACKGROUND

### 1. Technical Field

The present disclosure relates to an inertial sensor module and an electronic apparatus including the inertial sensor module.

### 2. Related Art

As an inertial sensor module that measures an acceleration, an angular velocity, or the like, for example, an inertial sensor module described in JP-A-2019-158425 is known.

JP-A-2019-158425 describes a circuit substrate on which a multi-axis inertial sensor that accommodates a three-axis angular velocity sensor and a three-axis acceleration sensor, a single-axis angular velocity sensor, and a connector are mounted.

In such an inertial sensor module, it is required to ensure a reliability of a detection accuracy when an external fluctuation such as a temperature change or a humidity change occurs.

### SUMMARY

According to an aspect of the present disclosure, there is provided an inertial sensor module including a first inertial sensor that detects a physical quantity of a first axis; a second inertial sensor that detects the physical quantity of the first axis; a first substrate on which the first inertial sensor and the second inertial sensor are mounted; and a second substrate on which the first substrate is mounted and which includes a first terminal electrically coupled to the first inertial sensor via the first substrate and a second terminal electrically coupled to the second inertial sensor via the first substrate.

According to another aspect of the present disclosure, there is provided an electronic apparatus including the inertial sensor module.

### BRIEF DESCRIPTION OF THE DRAWINGS

FIG. 1 is a perspective view of an inertial sensor module according to Embodiment 1.

FIG. 2 is a cross-sectional view of the inertial sensor module taken along the line II-II of FIG. 1.

FIG. 3 is a block diagram of the inertial sensor module.

FIG. 4 is a perspective view of an inertial measurement unit according to Embodiment 2.

FIG. 5 is a perspective view of the inertial measurement unit according to Embodiment 2.

FIG. 6 is an exploded perspective view of the inertial measurement unit according to Embodiment 2.

FIG. 7 is a perspective view of an inertial sensor module according to Embodiment 2.

FIG. 8 is a perspective view of an electronic apparatus according to Embodiment 3.

FIG. 9 is a perspective view of an electronic apparatus according to Embodiment 3.

### DESCRIPTION OF EMBODIMENTS

Hereinafter, embodiments of the present disclosure will be described with reference to the drawings.

In the following drawings, dimensions may be scaled differently depending on components in order to make the components easier to see.

In addition, in the following, for convenience of description, three axes orthogonal to each other are referred to as an X axis, a Y axis, and a Z axis. In addition, a direction parallel to the X axis is also referred to as an X-axis direction, a direction parallel to the Y axis is also referred to as a Y-axis direction, and a direction parallel to the Z axis is also referred to as a Z-axis direction. In addition, a tip end side in an arrow direction of each axis is also referred to as a positive side, and an opposite side is also referred to as a negative side. In addition, viewing in the Z-axis direction is also referred to as a plan view, and viewing from the Y-axis direction with respect to a cross section including the Z axis is also referred to as a cross-sectional view.

Further, in the following description, for example, the description of “on the substrate” refers to any of a case of being disposed in contact with the substrate, a case of being disposed on the substrate via another structure, or a case of being partially disposed in contact with the substrate and being partially disposed on the substrate via another structure. In addition, for example, the description of the “upper surface of the substrate” is assumed to indicate a surface of the substrate on the positive side in the Z-axis direction. In addition, for example, the description of the “lower surface of the substrate” is assumed to indicate a surface of the substrate on the negative side in the Z-axis direction.

### 1. Embodiment 1

In the present embodiment, first, a basic configuration of an inertial sensor module 100 according to Embodiment 1 will be described, and then, an application configuration will be described.

### 1.1. Basic Configuration of Inertial Sensor Module

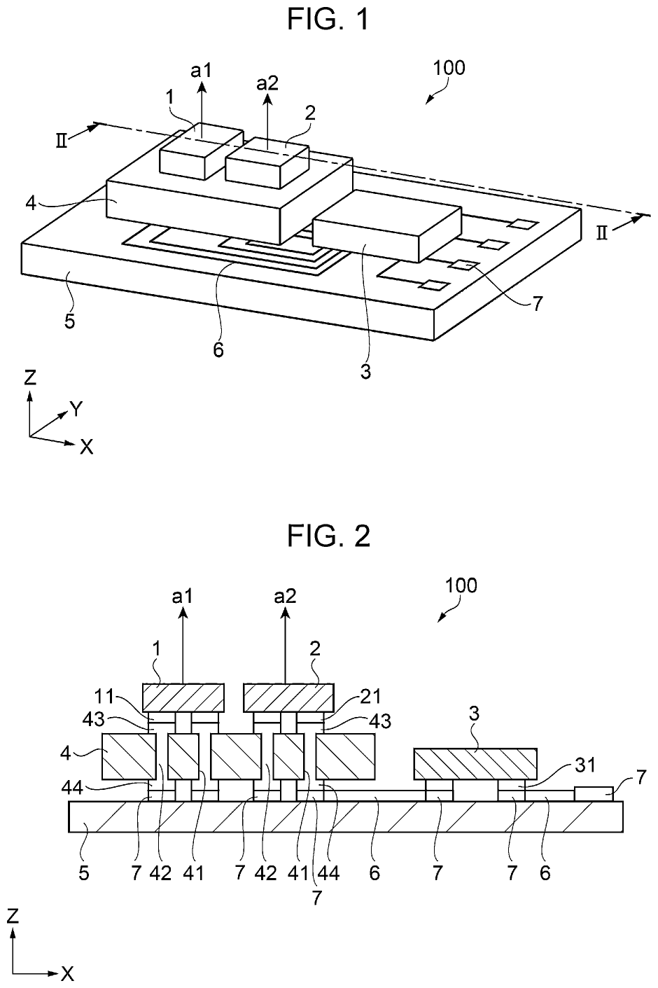

FIG. 1 is a perspective view of the inertial sensor module 100 according to Embodiment 1. FIG. 2 is a cross-sectional view taken along the line II-II of FIG. 1.

As illustrated in FIG. 1, the inertial sensor module 100 includes a first inertial sensor 1, a second inertial sensor 2, a processing device 3, an interposer 4, a substrate 5, a wiring 6, and a terminal 7. The first inertial sensor 1 and the second inertial sensor 2 are mounted on the interposer 4, and the interposer 4 and the processing device 3 are mounted on the substrate 5.

In the present embodiment, the first inertial sensor 1 is an example of a first inertial sensor. The second inertial sensor 2 is an example of a second inertial sensor. The processing device 3 is an example of a processing device. The interposer 4 is an example of a first substrate. The substrate 5 is an example of a second substrate.

The first inertial sensor 1 and the second inertial sensor 2 are inertial sensors that detect and output a physical quantity of a first axis, respectively.

For example, when the physical quantity of the first axis is an angular velocity around the Z axis, the first inertial sensor 1 and the second inertial sensor 2 are angular velocity sensors that detect the angular velocity around the Z axis, respectively.

The first inertial sensor 1 and the second inertial sensor 2 are devices in which a sensor element that detects the physical quantity of the first axis is accommodated in a package, and each are configured as one chip. Preferably, the first inertial sensor 1 and the second inertial sensor 2 each accommodate a sensor element, a detection circuit, and an output circuit in a package.

When the first inertial sensor 1 and the second inertial sensor 2 are angular velocity sensors that detect the angular velocity around the Z axis, the sensor elements of the first inertial sensor 1 and the second inertial sensor 2 are sensor elements that detect the angular velocity around the Z axis, respectively.

The detection circuit of the first inertial sensor 1 performs detection processing on a signal output from the sensor element, and the output circuit outputs the signal obtained by the detection processing as a first detection signal.

The detection circuit of the second inertial sensor 2 performs detection processing on a signal output from the sensor element, and the output circuit outputs the signal obtained by the detection processing as a second detection signal.

Each of the first inertial sensor 1 and the second inertial sensor 2 may have an A/D converter. The A/D converter generates a digital detection signal based on the angular velocity signal around the Z axis output from the sensor element.

The physical quantity of the first axis is not limited to the angular velocity around the Z axis. The physical quantity of the first axis may be an angular velocity around the X axis, an angular velocity around the Y axis, an acceleration of the X axis, an acceleration of the Y axis, and an acceleration of the Z axis. Further, the inertial sensor module 100 may have three or more inertial sensors that detect the physical quantity of the first axis.

In addition, the first inertial sensor 1 and the second inertial sensor 2 may be either a single-axis inertial sensor or a multi-axis inertial sensor. In addition, the first inertial sensor 1 and the second inertial sensor 2 may be either the same type of inertial sensors or different types of inertial sensors. The single-axis inertial sensor, the multi-axis inertial sensor, the same type of inertial sensors, and the different types of inertial sensors will be described in an application configuration described later.

The first axis coincides with a direction of a detection axis a1 of the first inertial sensor 1 and a direction of a detection axis a2 of the second inertial sensor 2. The direction of the detection axis a1 and the direction of the detection axis a2 are appropriately set according to the use, purpose, and the like of the inertial sensor module 100. When the direction of the detection axis a1 and the direction of the detection axis a2 are determined, the direction of the detection axis a1 and the direction of the detection axis a2 become the first axis.

For example, when the inertial sensor module 100 is used for a moving object such as an automobile, it is preferable that the first axis be used as an axis for calculating a yaw angle. This is because, when performing posture control or position measurement of the moving object, it is particularly effective to accurately calculate the yaw angle among a roll angle, a pitch angle, and the yaw angle of the moving object for improving the accuracy.

Here, when a traveling direction of the moving object is set as the X axis, a gravity direction of the moving object is set as the Z axis, and a direction orthogonal to the X axis and the Z axis is set as the Y axis, the yaw angle of the moving object is calculated by detecting the angular velocity around the Z axis.

Therefore, when the inertial sensor module 100 is used for the moving object, the direction of the detection axis a1 and the direction of the detection axis a2 may be provided to coincide with the Z axis. In this case, the Z axis is the first axis.

By aligning the direction of the detection axis a1 of the first inertial sensor 1 with the Z axis, the first inertial sensor 1 functions as a Z-axis angular velocity sensor that detects an angular velocity around the Z axis and outputs an angular velocity signal around the Z axis.

By aligning the direction of the detection axis a2 of the second inertial sensor 2 with the Z axis, the second inertial sensor 2 also functions as a Z-axis angular velocity sensor that detects the angular velocity around the Z axis and outputs an angular velocity signal around the Z axis.

The first inertial sensor 1 and the second inertial sensor 2 are mounted on an upper surface of the interposer 4. On the upper surface of the interposer 4, the direction of the detection axis a1 of the first inertial sensor 1 and the direction of the detection axis a2 of the second inertial sensor 2 are provided to coincide with the Z axis.

As described above, the inertial sensor module 100 of the present embodiment has two angular velocity sensors that detect the angular velocity around the Z axis, so that the redundancy of the sensor can be improved in detecting the angular velocity around the Z axis. Furthermore, the detection accuracy of the sensor can be improved in detecting the angular velocity around the Z axis.

A material having a higher elastic modulus than the substrate 5 and/or a material having a lower linear expansion coefficient than the substrate 5 is used for the interposer 4. As the interposer 4, for example, a glass epoxy substrate formed by mainly using a general-purpose resin such as an epoxy resin containing glass fibers can be used. The interposer 4 may be other rigid substrates such as a ceramic substrate or a composite substrate.

When the interposer 4 is made of a material having a higher elastic modulus than the substrate 5, deformation of the interposer 4 can be suppressed even when a physical bending stress as an external fluctuation is applied to the inertial sensor module 100.

Further, when the interposer 4 is made of a material having a lower linear expansion coefficient than the substrate 5, the deformation of the interposer 4 can be suppressed even when a temperature change as an external fluctuation occurs in the inertial sensor module 100.

Therefore, the inertial sensor module 100 of the present embodiment can suppress the deformation of the interposer 4 due to the external fluctuation, and accordingly, deviation of the detection axis a1 of the first inertial sensor 1 and/or the detection axis a2 of the second inertial sensor 2 from the Z axis. Therefore, it is possible to suppress a decrease in detection accuracy when the external fluctuation occurs. In other words, by mounting the first inertial sensor 1 and the second inertial sensor 2 on the interposer 4, the reliability of the detection accuracy is maintained or ensured even when the external fluctuation occurs.

The interposer 4 does not need to have both features that the elastic modulus is larger than that of the substrate 5 and that the linear expansion coefficient is smaller than that of the substrate 5. The feature to be provided in the interposer 4 may be selected according to an expected external fluctuation.

As illustrated in FIG. 2, the interposer 4 has a through-hole 41, a conductive member 42 provided in the through-hole 41, and electrodes 43 and 44 electrically coupled to the conductive member 42. Although the conductive member 42 is provided in the through-hole 41, the conductive member 42 may be provided in a non-through-hole (not illustrated) instead of the through-hole 41. In other words, the through-hole 41 may be divided into a plurality of non-through-holes. In this case, the electrode 43 and the electrode 44 are electrically coupled to each other via a plurality of conductive members 42 provided in the plurality of non-through-holes and a wiring that couples the plurality of conductive members 42. In addition, in FIG. 2, the conductive member 42, the electrode 43, and the electrode 44 overlap each other in a plan view as viewed from the Z-axis direction, but the electrode 43 and the electrode 44 may not overlap each other.

The first inertial sensor 1 is mounted on the interposer 4. The first inertial sensor 1 has a plurality of electrodes 11 on a lower surface thereof, and is mounted on the interposer 4 such that the electrodes 11 are coupled to the electrodes 43 of the interposer 4.

The first inertial sensor 1 may be fixed to the upper surface of the interposer 4 by an adhesive material (not illustrated) or the like provided between the interposer 4 and the first inertial sensor 1.

The second inertial sensor 2 is mounted on the interposer 4. The second inertial sensor 2 has a plurality of electrodes 21 on a lower surface thereof, and is mounted on the interposer 4 such that the electrodes 21 are coupled to the electrodes 43 of the interposer 4.

The second inertial sensor 2 may be fixed to the upper surface of the interposer 4 by an adhesive material (not illustrated) or the like provided between the interposer 4 and the second inertial sensor 2.

The interposer 4 and the processing device 3 are mounted on an upper surface of the substrate 5.

The upper surface of the substrate 5 is provided with a terminal 7 as a first terminal or a second terminal and a wiring 6 electrically coupled to the terminal 7.

The interposer 4 is mounted on the substrate 5 such that the electrode 44 on a lower surface thereof is coupled to the terminal 7 of the substrate 5. The interposer 4 may be fixed to the upper surface of the substrate 5 by an adhesive or the like (not illustrated) provided between the substrate 5 and the interposer 4. The first inertial sensor 1 is electrically coupled to the terminal 7 of the substrate 5 via the conductive member 42 of the interposer 4. Here, the conductive member 42 may be provided in the through-hole 41 or may be provided in the non-through-hole. The second inertial sensor 2 is electrically coupled to the terminal 7 of the substrate 5 via the conductive member 42 of the interposer 4. Here, the conductive member 42 may be provided in the through-hole 41 or may be provided in the non-through-hole.

The processing device 3 includes a plurality of electrodes 31 on a lower surface thereof.

The processing device 3 is mounted on the substrate 5 such that the electrode 31 is coupled to the terminal 7 of the substrate 5. The processing device 3 may be fixed to the upper surface of the substrate 5 by an adhesive or the like (not illustrated) provided between the substrate 5 and the processing device 3.

The processing device 3 is, for example, a micro controller unit (MCU), and is configured as a one-chip IC. The first inertial sensor 1 and the second inertial sensor 2 are coupled to the processing device 3 by the conductive member 42 of the interposer 4 and the wiring 6 of the substrate 5.

The processing device 30 performs reading processing of the first detection signal from the first inertial sensor 1 and the second detection signal from the second inertial sensor 2.

The processing device 30 receives the first detection signal output from the first inertial sensor 1, generates first detection data based on the first detection signal, receives the second detection signal output from the second inertial sensor 2, and generates second detection data based on the second detection signal.

The processing device 3 performs various arithmetic processing on the first detection signal and the second detection signal. The arithmetic processing is, for example, averaging processing. The processing device 3 may include a function of correcting temperature characteristics, misalignment, and the like.

The processing device 3 includes a storage unit including a non-volatile memory and the like. The storage unit stores a program or data for executing various functions such as averaging processing.

### 1.2. Application Configuration of Inertial Sensor Module

### 1.2.1. Application Configuration 1

In the inertial sensor module 100 according to Application Configuration 1, the first inertial sensor 1 and the second inertial sensor 2 are different in type and the number of detection axes.

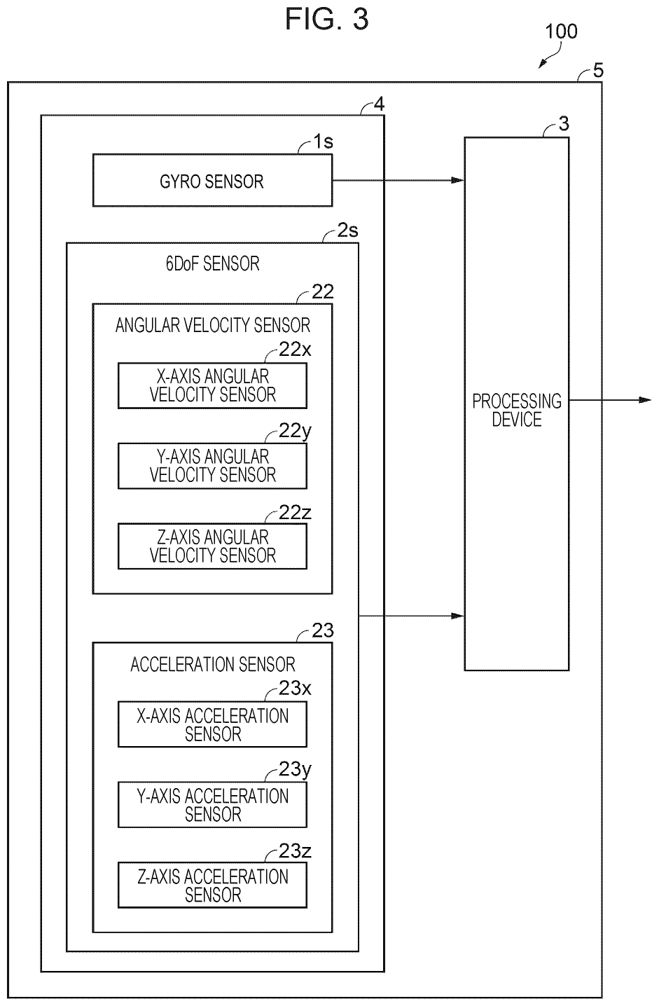

FIG. 3 is a block diagram illustrating a configuration of the inertial sensor module 100 according to Application Configuration 1.

The inertial sensor module 100 according to Application Configuration 1 includes a single-axis gyro sensor 1s as the first inertial sensor 1 and a multi-axis six-degree-of-freedom (6DoF) sensor 2s as the second inertial sensor 2.

The gyro sensor 1s and the 6DoF sensor 2s are mounted on the interposer 4, and the interposer 4 and the processing device 3 are mounted on the substrate 5.

The single-axis gyro sensor 1s is specifically a quartz crystal gyro that detects an angular velocity from a Coriolis force applied to a vibrating object, and is an angular velocity sensor having a higher accuracy than the second inertial sensor 2.

The 6DoF sensor 2s is a multi-axis inertial sensor that is equipped with a three-axis angular velocity sensor 22 and a three-axis acceleration sensor 23. In other words, the single-axis gyro sensor 1s and the 6DoF sensor 2s are different in the number of detection axes.

In the 6DoF sensor 2s, the angular velocity sensor 22 is a capacitance change-type silicon-micro electro mechanical systems (Si-MEMS) angular velocity sensor, and the acceleration sensor 23 is a capacitance change-type Si-MEMS acceleration sensor. In other words, the gyro sensor 1s and the 6DoF sensor 2s differ in the type of sensors.

The gyro sensor 1s may be a multi-sensor using a plurality of capacitance change-type Si-MEMS, a fiber optic gyro (FOG), or the like. In addition, the angular velocity sensor 22 of the 6DoF sensor 2s may be a quartz crystal gyro or the like, and the acceleration sensor 23 may be a quartz crystal acceleration sensor, a piezo-resistive acceleration sensor, and a thermosensitive acceleration sensor.

The angular velocity sensor 22 of the 6DoF sensor 2s includes an X-axis angular velocity sensor 22x, a Y-axis angular velocity sensor 22y, and a Z-axis angular velocity sensor 22z.

The X-axis angular velocity sensor 22x detects an angular velocity around the X-axis and outputs a first angular velocity signal. The Y-axis angular velocity sensor 22y detects an angular velocity around the Y-axis and outputs a second angular velocity signal. The Z-axis angular velocity sensor 22z detects an angular velocity around the Z-axis and outputs a third angular velocity signal.

The acceleration sensor 23 of the 6DoF sensor 2s includes an X-axis acceleration sensor 23x, a Y-axis acceleration sensor 23y, and a Z-axis acceleration sensor 23z.

The X-axis acceleration sensor 23x detects an acceleration in the X-axis direction and outputs a first acceleration signal. The Y-axis acceleration sensor 23y detects an acceleration in the Y-axis direction and outputs a second acceleration signal. The Z-axis acceleration sensor 23z detects an acceleration in the Z-axis direction and outputs a third acceleration signal.

The inertial sensor module 100 according to Application Configuration 1 can be used in, for example, the automobile described above.

In this case, the first axis is an axis for calculating the yaw angle, that is, the Z axis.

Therefore, the direction of the detection axis a1 of the gyro sensor 1s and the direction of the detection axis a2 of the Z-axis angular velocity sensor 22z are provided to coincide with the Z-axis. The first axis is not limited to the Z axis. The first axis may be appropriately set to the X axis or the Y axis according to the use, purpose, and the like.

In the inertial sensor module 100 according to Application Configuration 1, the gyro sensor 1s and the 6DoF sensor 2s are mounted on the interposer 4, and the interposer 4 and the processing device 3 are mounted on the substrate 5.

Therefore, according to the inertial sensor module 100 according to Application Configuration 1, even when an external fluctuation occurs, a decrease in detection accuracy of the gyro sensor 1s and/or the 6DoF sensor 2s is suppressed. Therefore, even when an external fluctuation occurs, the reliability of the detection accuracy of the inertial sensor module 100 is maintained or ensured.

Further, the inertial sensor module 100 according to Application Configuration 1 has a plurality of angular velocity sensors of the gyro sensor 1s and the Z-axis angular velocity sensor 22z as the angular velocity sensor that detects the angular velocity around the Z-axis, so that the redundancy of the sensor can be improved in detecting the angular velocity around the Z-axis.

Further, by using the single-axis gyro sensor 1s having a higher accuracy than the second inertial sensor 2, as the first inertial sensor 1, the detection accuracy can be improved. Regarding this point, the present applicant has found through experiments of the present inventors that the detection accuracy can be improved by using the single-axis gyro sensor 1s and the 6DoF sensor 2s compared to when they are used alone.

Furthermore, the inertial sensor module 100 including the single-axis gyro sensor 1s and the 6DoF sensor 2s is less expensive than a three-axis quartz crystal gyro sensor, but can realize the same detection accuracy as the expensive three-axis quartz crystal gyro sensor. Therefore, it is possible to realize the inertial sensor module 100 which is highly practical and has a high industrial utility value.

### 1.2.2. Application Configuration 2

In the inertial sensor module 100 according to Application Configuration 2, the first inertial sensor 1 and the second inertial sensor 2 are the same in type and/or the number of detection axes.

Specifically, the inertial sensor module 100 according to Application Configuration 2 includes the 6DoF sensor 2s as the first inertial sensor 1 and the 6DoF sensor 2s as the second inertial sensor 2.

Alternatively, the inertial sensor module 100 according to Application Configuration 2 includes the single-axis gyro sensor 1s as the first inertial sensor 1 and the single-axis gyro sensor 1s as the second inertial sensor 2.

Alternatively, the inertial sensor module 100 according to Application Configuration 2 includes the three-axis angular velocity sensor as the first inertial sensor 1 and the three-axis angular velocity sensor as the second inertial sensor 2.

Alternatively, the inertial sensor module 100 according to Application Configuration 2 includes the three-axis acceleration sensor as the first inertial sensor 1 and the three-axis acceleration sensor as the second inertial sensor 2.

In the inertial sensor module 100 according to Application Configuration 2, the first axis may be any of the X axis, the Y axis, and the Z axis.

In addition, in the inertial sensor module 100 according to Application Configuration 2, the physical quantity of the first axis detected by the first inertial sensor 1 and the second inertial sensor 2 may be any of an angular velocity around the X axis, an angular velocity around the Y axis, an angular velocity around the Z axis, an acceleration in the X-axis direction, an acceleration in the Y-axis direction, and an acceleration in the Z-axis direction.

The inertial sensor module 100 according to Application Configuration 2 has two inertial sensors of the first inertial sensor 1 and the second inertial sensor 2, but may have three or more inertial sensors.

As described above, according to the inertial sensor module 100 of the present embodiment, the following effects can be obtained.

The inertial sensor module 100 of the present embodiment includes the first inertial sensor 1 that detects the angular velocity around the Z axis as the physical quantity of the first axis, the second inertial sensor 2 that detects the angular velocity around the Z axis, the interposer 4 as the first substrate on which the first inertial sensor 1 and the second inertial sensor 2 are mounted, and the substrate 5 as the second substrate on which the interposer 4 is mounted and which includes the terminal 7 as a first terminal electrically coupled to the first inertial sensor 1 via the interposer 4 and the terminal 7 as a second terminal electrically coupled to the second inertial sensor 2 via the interposer 4.

As described above, in the inertial sensor module 100, the first inertial sensor 1 that detects the angular velocity around the Z axis and the second inertial sensor 2 that detects the angular velocity around the Z axis are mounted on the interposer 4, and the interposer 4 is mounted on the substrate 5.

Therefore, the inertial sensor module 100 of the present embodiment can suppress a decrease in reliability of the detection accuracy of the first inertial sensor 1 and/or the second inertial sensor 2 even when an external fluctuation such as application of a bending stress, a temperature change, or a humidity change occurs. Therefore, according to the inertial sensor module 100 of the present embodiment, even when the external fluctuation occurs, the reliability of the detection accuracy of the inertial sensor module 100 is maintained or ensured.

Further, in the inertial sensor module 100 of the present embodiment, the interposer 4 as the first substrate includes the conductive member 42 as a first conductive member that electrically couples the first inertial sensor 1 and the terminal 7 as a first terminal, and the conductive member 42 as a second conductive member that electrically couples the second inertial sensor 2 and the terminal 7 as a second terminal.

As described above, in the inertial sensor module 100, the first inertial sensor 1 is electrically coupled to the terminal 7 via the conductive member 42 of the interposer 4, and the second inertial sensor 2 is electrically coupled to the terminal 7 via the conductive member 42 of the interposer 4.

Therefore, the inertial sensor module 100 of the present embodiment can suppress a decrease in reliability of the detection accuracy because a reliability of electrical coupling is maintained even when an external fluctuation such as application of a bending stress, a temperature change, or a humidity change occurs.

Further, in the inertial sensor module 100 of the present embodiment, the elastic modulus of the interposer 4 as the first substrate is larger than the elastic modulus of the substrate 5 as the second substrate.

As described above, when the interposer 4 is made of a material having a higher elastic modulus than the substrate 5, even when a physical bending stress as an external fluctuation is applied to the inertial sensor module 100, the deformation of the interposer 4 can be suppressed.

Therefore, the inertial sensor module 100 of the present embodiment can suppress a decrease in detection accuracy which is caused by the interposer 4 being deformed due to the external fluctuation, and accordingly, the detection axis a1 as the first axis of the first inertial sensor 1 and/or the detection axis a2 as the first axis of the second inertial sensor 2 being deviated from the Z axis.

Further, in the inertial sensor module 100 of the present embodiment, the linear expansion coefficient of the interposer 4 as the first substrate is smaller than the linear expansion coefficient of the substrate 5 as the second substrate.

As described above, when the interposer 4 is made of a material having a lower linear expansion coefficient than the substrate 5, the deformation of the interposer 4 can be suppressed even when a temperature change or a humidity change as an external fluctuation occurs in the inertial sensor module 100.

Therefore, the inertial sensor module 100 of the present embodiment can suppress a decrease in detection accuracy which is caused by the interposer 4 being deformed due to the external fluctuation, and accordingly, the detection axis a1 as the first axis of the first inertial sensor 1 and/or the detection axis a2 as the first axis of the second inertial sensor 2 being deviated from the Z axis.

Further, the inertial sensor module 100 of the present embodiment includes the processing device 3 that processes the first detection signal from the first inertial sensor 1 and the second detection signal from the second inertial sensor 2.

Therefore, the inertial sensor module 100 of the present embodiment can execute processing with high reliability.

Further, in the inertial sensor module 100 of the present embodiment, the processing device 3 is mounted on the substrate 5 as the second substrate.

As described above, the processing device 3 is not mounted on the interposer 4.

Therefore, the inertial sensor module 100 of the present embodiment can suppress the deformation of the interposer 4 when an external fluctuation is applied to the inertial sensor module 100 compared to when the processing device 3 is mounted on the interposer 4.

### Embodiment 2

In Embodiment 2, an inertial measurement unit (IMU) 200 including the inertial sensor module 100 will be described.

### 2.1. Overview of Inertial Measurement Unit

The inertial measurement unit 200 is mounted on a mounting device, for example, an automobile, a smartphone, or the like, and is used to detect a posture or behavior of the mounting device.

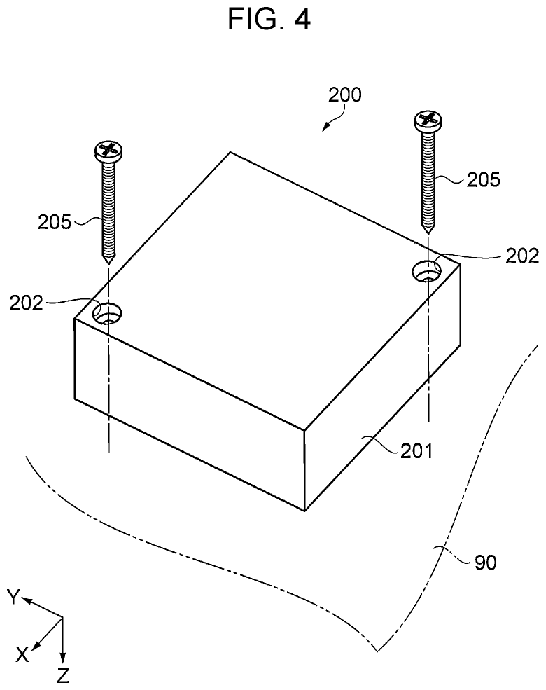

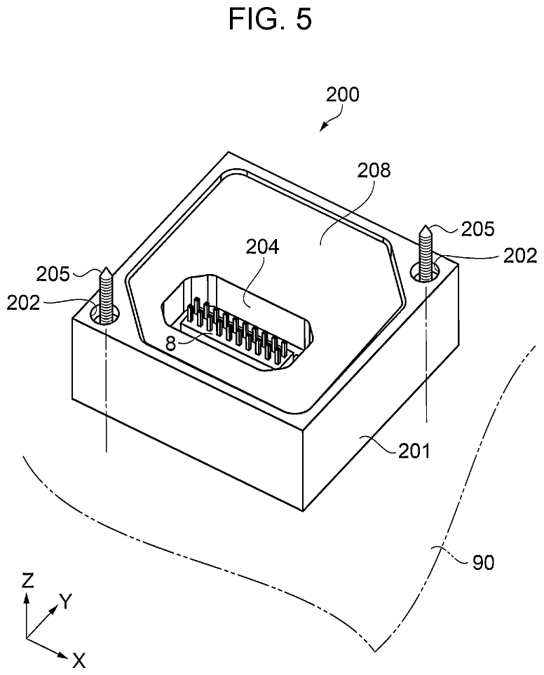

FIG. 4 is a perspective view of the inertial measurement unit 200 according to Embodiment 2, and is a view illustrating a state in which the inertial measurement unit 200 is fixed to a mounting surface 90 of the mounting device. FIG. 5 is a perspective view of the inertial measurement unit 200 as viewed from the mounting surface 90 side.

In Embodiment 2, the inertial measurement unit 200 is a rectangular parallelepiped having a square planar shape, and screw holes 202 as fixing portions are formed near two vertices located in a diagonal direction of a square. The inertial measurement unit 200 is used by being fixed to the mounting surface 90 of the mounting device by screws 205 passed through the screw holes 202. The shape and the fixing method of the inertial measurement unit 200 described above are examples, and suitable shapes and fixing methods can be adopted depending on the intended use and the like.

As illustrated in FIG. 5, an opening portion 204 is formed at a surface of the inertial measurement unit 200 on the mounting surface 90 side. The plug-type connector 8 is disposed inside the opening portion 204.

The connector 8 has a plurality of pins disposed in parallel. A socket-type connector (not illustrated) is coupled to the connector 8 from the mounting device. An electric signal is transmitted and received between the inertial measurement unit 200 and the mounting device via the connector 8, the electric signal including power supply to the inertial measurement unit 200, detection data output to the mounting device, and the like.

### 2.2. Configuration of Inertial Measurement Unit

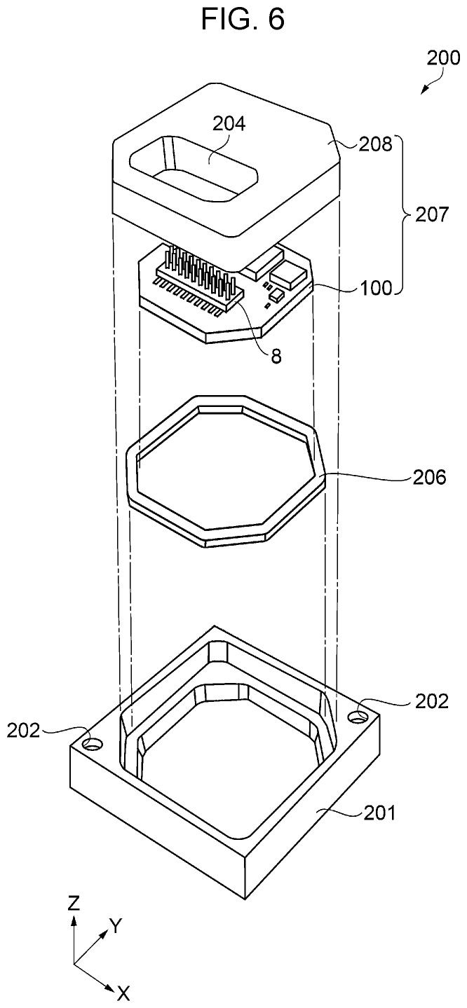

FIG. 6 is an exploded perspective view of the inertial measurement unit 200, and is an exploded perspective view of the inertial measurement unit 200 as viewed from the same direction as in FIG. 5.

As illustrated in FIG. 6, the inertial measurement unit 200 includes an outer case 201, an annular buffer material 206, and an inertial sensor unit 207. In other words, the inertial measurement unit 200 includes the inertial sensor unit 207 mounted inside the outer case 201 with the annular buffer material 206 interposed therebetween. The inertial sensor unit 207 includes an inner case 208 and the inertial sensor module 100.

The outer shape of the outer case 201 is a rectangular parallelepiped having a square planar shape, and the screw holes 202 are formed near two vertices located in a diagonal direction of a square. The planar shape of the outer case 201 may be, for example, a polygon such as a hexagon or an octagon.

### 2.3. Configuration of Inertial Sensor Module

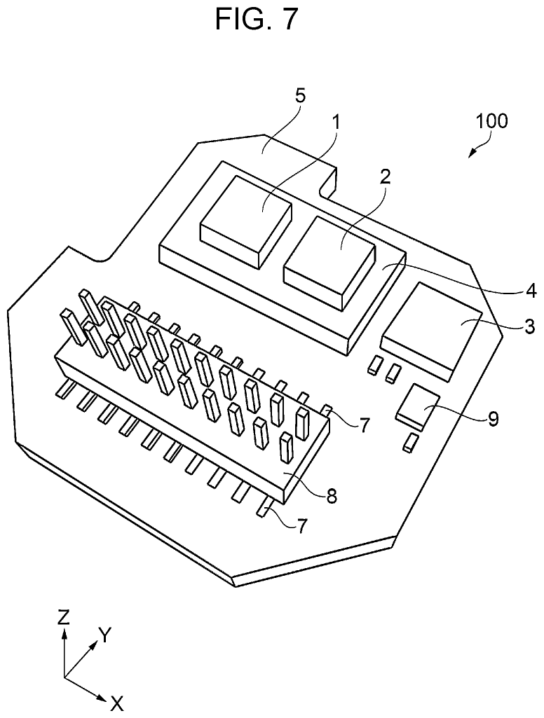

FIG. 7 is a perspective view of the inertial sensor module 100 mounted on the inertial measurement unit 200.

The inertial sensor module 100 according to Embodiment 2 is different from the inertial sensor module 100 according to Embodiment 1 in that the substrate 5 includes the connector 8, a global positioning system (GPS) module 9, and other circuit components. The same components as those in Embodiment 1 are denoted by the same reference numerals, and the description thereof will not be repeated.

The interposer 4 on which the first inertial sensor 1 and the second inertial sensor 2 are mounted, the processing device 3, the connector 8, the GPS module 9, and other circuit components are mounted on the upper surface of the substrate 5.

The connector 8 is a plug-type connector, and is provided with external coupling terminals formed of a plurality of pins. Further, the connector 8 is not limited to such a form. For example, the connector 8 may be a lead, a coupling electrode, an optical connector, or a non-contact connector.

The inertial sensor module 100 may have a temperature sensor, a magnetic sensor, a capacitor, or the like. When the temperature sensor or the magnetic sensor is mounted, the temperature sensor or the magnetic sensor is mounted on the interposer 4. This is because, when the temperature sensor or the magnetic sensor is disposed close to the first inertial sensor 1 and the second inertial sensor 2, the measurement can be performed accurately.

As described above, the inertial measurement unit 200 of Embodiment 2 includes the inertial sensor module 100. The inertial sensor module 100 maintains or ensures the reliability of the detection accuracy even when an external fluctuation such as application of a bending stress, a temperature change, or a humidity change is applied.

Therefore, according to the inertial measurement unit 200 of Embodiment 2, it is possible to realize the inertial measurement unit 200 with which the reliability of the detection accuracy is maintained or ensured when an external fluctuation is applied.

### 3. Embodiment 3

In Embodiment 3, an electronic apparatus including the inertial sensor module 100 will be described.

In the following, as examples of the electronic apparatus, an example of a moving object such as an automobile and an example of a portable device such as a smartphone will be described.

### 3.1. Overview of Moving Object

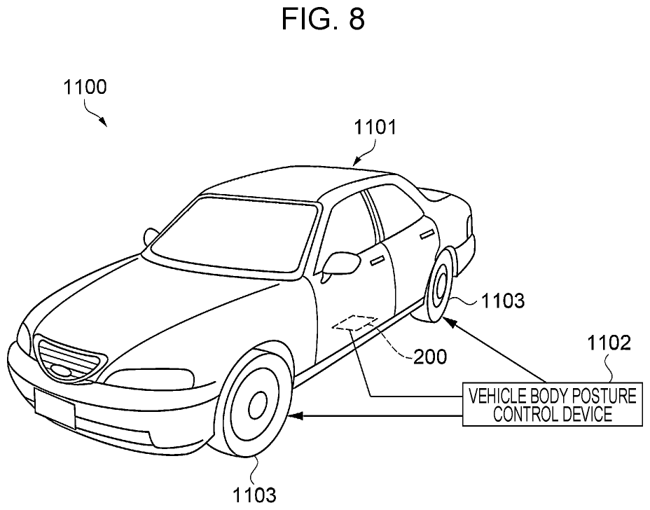

FIG. 8 is a perspective view of a moving object as an electronic apparatus according to Embodiment 3, and is a view illustrating a configuration of an automobile 1100 as an example of the moving object.

The automobile 1100 is equipped with the inertial measurement unit 200 including the inertial sensor module 100.

The inertial measurement unit 200 detects a posture of a vehicle body 1101 and outputs a detection signal. The detection signal includes an angular velocity signal and an acceleration signal. The detection signal of the inertial measurement unit 200 is supplied to a vehicle body posture control device 1102 that controls the posture of the vehicle body 1101.

The vehicle body posture control device 1102 detects the posture of the vehicle body 1101 based on the detection signal, and controls hardness/softness of a suspension or controls brakes of individual wheels 1103 according to a detection result.

In addition, the detection signal of the inertial measurement unit 200 may be used in other applications such as a keyless entry, an immobilizer, a car navigation system, a car air conditioner, an anti-lock brake system (ABS), an airbag, a tire pressure monitoring system (TPMS), an engine control, a control device of inertial navigation for autonomous driving, and an electronic control unit (ECU) such as a battery monitor for a hybrid automobile or an electric automobile.

In addition, the inertial measurement unit 200 may be mounted on other moving objects other than the automobile 1100. For example, the inertial measurement unit 200 is mounted on a moving object such as a bipedal robot, a train, a radio-controlled airplane, a radio-controlled helicopter, a drone, an agricultural machine, and a construction machine. As a result, the moving object can use the detection signal of the inertial measurement unit 200 for posture control, position measurement, and the like of the moving object.

As described above, in the present embodiment, the moving object such as the automobile 1100 is equipped with the inertial measurement unit 200 including the inertial sensor module 100. The inertial sensor module 100 can maintain or ensure the reliability of the detection accuracy even when an external fluctuation such as application of a bending stress, a temperature change, or a humidity change is applied.

Therefore, according to the present embodiment, it is possible to improve the reliability of the moving object including the inertial sensor module 100.

### 3.2. Overview of Portable Device

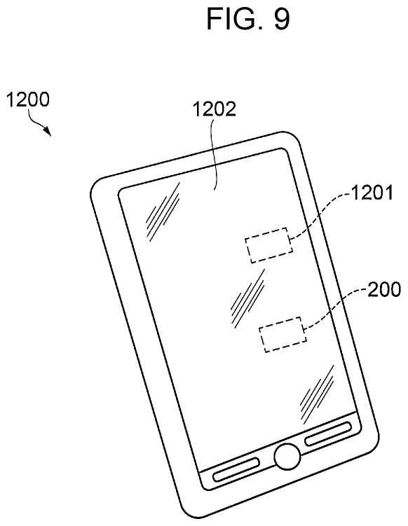

FIG. 9 is a perspective view of a portable device as the electronic apparatus according to Embodiment 3, and is a view illustrating a configuration of a smartphone 1200 as an example of the portable device.

The smartphone 1200 is equipped with the inertial measurement unit 200 including the inertial sensor module 100.

The detection signal detected by the inertial measurement unit 200 is output to a control circuit 1201, and the control circuit 1201 can recognize a posture or behavior of the smartphone 1200 from the received detection signal, and can change a display image displayed on a display section 1202, sound a warning sound or an effect sound, or drive a vibration motor to vibrate a main body.

In addition, the inertial measurement unit 200 may be mounted on other portable devices other than the smartphone 1200. For example, the inertial measurement unit 200 may be mounted on a portable device such as a smartwatch, a portable activity meter, a head mounted display (HMD), a mobile personal computer (PC), a tablet PC, a camera, and a personal digital assistant (PDA). As a result, the portable device can recognize the posture and behavior of the portable device by the detection signal from the inertial measurement unit 200, and can change the display image, sound a warning sound or an effect sound, drive the vibration motor to vibrate the main body, or the like.

As described above, in the present embodiment, a portable device such as the smartphone 1200 is equipped with the inertial measurement unit 200 including the inertial sensor module 100. The inertial sensor module 100 can maintain or ensure the reliability of the detection accuracy even when an external fluctuation such as application of a bending stress, a temperature change, or a humidity change is applied.

Therefore, according to the present embodiment, it is possible to improve the reliability of the portable device including the inertial sensor module 100.

As described above, the automobile 1100 and the smartphone 1200 as the electronic apparatus of the present embodiment include the inertial sensor module 100 described above.

Therefore, it is possible to improve the reliability of the automobile 1100 and the smartphone 1200.

The preferred embodiments have been described above, but the present disclosure is not limited to the above-described embodiments. In addition, the configuration of each portion of the present disclosure can be replaced with any configuration that exhibits the same functions as those of the above-described embodiments, and any configuration can be added.

What is claimed is:

1. An inertial sensor module comprising:
a first inertial sensor that detects a physical quantity of a first axis;
a second inertial sensor that detects the physical quantity of the first axis;
a first substrate on which the first inertial sensor and the second inertial sensor are mounted; and
a second substrate on which the first substrate is mounted and which includes a first terminal electrically coupled to the first inertial sensor via the first substrate and a second terminal electrically coupled to the second inertial sensor via the first substrate.

2. The inertial sensor module according to claim 1, wherein
the first substrate includes a first conductive member that electrically couples the first inertial sensor and the first terminal, and a second conductive member that electrically couples the second inertial sensor and the second terminal.

3. The inertial sensor module according to claim 1, wherein
an elastic modulus of the first substrate is larger than an elastic modulus of the second substrate.

4. The inertial sensor module according to claim 1, wherein
a linear expansion coefficient of the first substrate is smaller than a linear expansion coefficient of the second substrate.

5. The inertial sensor module according to claim 1, further comprising:
a processing device that processes a first detection signal from the first inertial sensor and a second detection signal from the second inertial sensor.

6. The inertial sensor module according to claim 5, wherein
the processing device is mounted on the second substrate.

7. The inertial sensor module according to claim 1, wherein
the first inertial sensor and the second inertial sensor are different in type and the number of detection axes.

8. The inertial sensor module according to claim 7, wherein
the first inertial sensor is a quartz crystal gyro that detects an angular velocity from a Coriolis force applied to a vibrating object.

9. The inertial sensor module according to claim 7, wherein
the second inertial sensor is equipped with a three-axis angular velocity sensor and a three-axis acceleration sensor.

10. The inertial sensor module according to claim 1, wherein
the first inertial sensor and the second inertial sensor are the same in type and the number of detection axes.

11. The inertial sensor module according to claim 10, wherein
the first inertial sensor and the second inertial sensor are quartz crystal gyros that detect an angular velocity from a Coriolis force applied to a vibrating object.

12. The inertial sensor module according to claim 10, wherein
each of the first inertial sensor and the second inertial sensor are equipped with a three-axis angular velocity sensor.

13. An electronic apparatus comprising the inertial sensor module according to claim 1.
